(19) United States
(12) Patent Application Publication
(10) Pub. No.: US 2023/0035843 A1
(43) Pub. Date: Feb. 2, 2023

(54) A POLYHALITE AND SOP GRANULE AND A PROCESS FOR THE PRODUCTION THEREOF

(71) Applicant: ICL EUROPE COOPERATIEF U.A., Amster-dam (NL)

(72) Inventors: Khalil ABU-RABEAH, Beer Sheva (IL); Natalia GEINIK, Arad (IL); Yacov LEVY, Dimona (IL); Marina DAKOV, Arad (IL); Ruben SOCOLOVSKY, Beer Sheva (IL); Moshe GOLDFARB, Beer Sheva (IL)

(21) Appl. No.: 17/785,098

(22) PCT Filed: Nov. 6, 2020
(86) PCT No.: PCT/IL2020/051156

§ 371 Date: Jun. 14, 2022

Related U.S. Application Data
(60) Provisional application No. 62/956,647, filed on Jan. 3, 2020.

(51) Int. Cl. C05D 1/00; C05G 5/12; C05G 5/40

(52) U.S. Cl. CPC C05D 1/005; C05G 5/12; C05G 5/40

(57) ABSTRACT

According to some embodiments, there is provided herein a fertilizer granule comprising Polyhalite and Sulphate of Potash (SOP), wherein the granule comprises a granule strength of at least 0.5 Kg/granule.

### FIELD OF THE INVENTION

The present invention relates to the field of fertilizers, specifically to a granule comprising polyhalite and potassium sulphate.

### BACKGROUND OF THE INVENTION

To grow properly, plants need macronutrients:

Nitrogen (N): leaf growth;

Phosphorus (P): Development of roots, flowers, seeds, fruit;

Potassium (K): Strong stem growth, movement of water in plants, promotion of flowering and fruiting; three secondary macronutrients: calcium (Ca), magnesium (Mg), and sulphur (S);

And micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

In this patent we describe granulation of composite fertilizer which contain polyhalite and potassium salt.

### SUMMARY OF THE INVENTION

According to some demonstrative embodiments there is provided herein a fertilizer granule comprising Polyhalite and Sulphate of Potash (SOP), wherein said granule comprises a granule strength of at least 0.5 Kg/granule.

According to some embodiments, the granule may further comprise a binder, selected from the group including starch, activated starch, activated starch with potassium silicate; meta kaolin; potassium silicate; sodium silicate or a combination thereof.

According to some embodiments, the binder may be activated starch.

According to some embodiments, the activated starch may be present in a concentration of 2% w/w.

According to some embodiments, the granule may comprise a ratio of polyhalite to SOP of 1:4 to 4:1.

Preferably the ratio may be between 1:2 to 2:1.

Most preferably the ratio may be 1.1:0.9 (11:9) to 0.9:1.1 (also referred to herein as 55:45).

According to some embodiments, there is provided herein a process for the granulation of Polyhalite with SOP comprising: mixing a feed of polyhalite with a feed of Potassium Sulphate salt and binder in a mixer to yield a mixture; granulating the mixture in a granulator to yield masses; crushing the masses in a crusher to yield particles; and screening the particles in a screener to yield different particles in three different sizes: oversized particles which undergo a second crushing process and are retuned to said screener for screening, undersized particles which are transferred to said mixer for further mixing, and desired size granular particles which are transferred to a polish screener.

According to some embodiments, the particles may comprise: N, K₂O, SO₄, MgO and CaO.

### DETAILED DESCRIPTION OF THE INVENTION

There is provided herein a process for the granulation of Polyhalite with a Sulphate of Potash (SOP) also referred to as Potassium Sulphate.

According to some demonstrative embodiments, the process may comprise:
mixing a feed of polyhalite with a feed of said Potassium Sulphate salt and binder in a mixer to yield a mixture;
granulating the mixture in a granulator to yield masses;
crushing the masses in a crusher to yield particles; and
screening the particles in a screener to yield different particles in three different sizes: oversized particles which undergo a second crushing process and are retuned to said screener for screening, undersized particles which are transferred to said mixer for further mixing, and desired size granular particles which are transferred to a polish screener.

According to some embodiments, the final product may contain: N, K₂O, SO₄, MgO, CaO

According to some embodiments there is provided herein a granule comprising a mixture of polyhalite, for example, 40-60% w/v and SOP, for example, in a concentration of 40-60% and optionally a binder.

According to some embodiments, the granule may comprise superior properties, in comparison to a granule comprising only polyhalite or only SOP.

According to some embodiments, Potassium sulfate (in British English potassium sulphate (SOP), also called sulphate of potash, arcanite, or archaically known as potash of sulfur) is the inorganic compound with formula K₂SO₄.

Polyhalite is an evaporite mineral, a hydrated sulfate of potassium, calcium and magnesium with formula: K₂Ca₂Mg(SO₄)₄·2H₂O.

According to some embodiments, it has been surprisingly found that although both polyhalite and SOP are both sulphate salts, the resulting granule exhibits superior strength properties]

According to some demonstrative embodiments, adding SOP to a polyhalite granule elevates the concentrations of Potassium and sulphate in the granule, while maintaining the granule as chloride free.

According to some demonstrative embodiments, a number of cash crops, such as vegetables, fruits, nuts and field crops, are known for their sensitivity to chloride. Chloride toxicity is expressed in the affected plants as leaf scorching. When the chloride concentration in the soil solution increases, plants take up chloride on the account of essential anionic nutrients, and this may result in reduced crop yield and quality.

Traditional preparation processes of chloride-free potash fertilizers (KNO₃, K₂CO₃ and K₂SO₄) have certain limitations, such as complicated operation and existing potential pollution.

According to some demonstrative embodiments, the combination of SOP and polyhalite in a single granule possess numerous surprising advantages.

According to some embodiments, the granule of the present invention comprises two different sources for providing the plant with Potassium and Sulphate. According to some embodiments, the first source may be polyhalite, and the second source may be SOP. According to some embodiments, SOP and Polyhalite comprise different dissolution rates, and according to some embodiments enable a plant exposed to the granule of the present invention to absorb vital nutrients such as Potassium and Sulphate in quick rate and in a controlled, e.g., slower, rate.

According to some embodiments, the dissolution quantity of SOP is 120 g L⁻¹ at 25° C.

According to some embodiments, it possible that the dissolution of SOP can further be enhanced by adding one or more additives which ameliorate the diffusion coefficient (D) and the diffusion layer thickness (h), such as sodium tripolyphosphate (STPP) and/or urea phosphate (UP).

Polyhalite on the other hand, upon contact with water may precipitate as gypsum and syngenite and magnesium sulphate.

According to some embodiments, the granule of the present invention may further include one or more additional fertilizers, for example, selected from the group including any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some demonstrative embodiments, the granule of the present invention may also include one or more binders, e.g., selected from the group including any suitable material or compound that may mechanically and/or chemically hold or draw other materials together to form a cohesive whole including, for example, organic or inorganic binders, such as, starch, bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, or combinations thereof.

According to some demonstrative embodiments, the binder may preferably be selected from the group including: Starch, most preferably, activated starch, whether alone or in combination with potassium silicate; meta kaolin; potassium silicate; sodium silicate or a combination thereof.

According to some preferable embodiments, the binder is activated starch.

According to some embodiments, the granule of the present invention may comprise a binder in a concentration of between 0.1-5% w/w, preferably 0.5-3% w/w, most preferably 1-2% w/w.

According to some embodiments, the ratio between polyhalite and SOP in the granule may be 1.1:0.9 to 0.9:1.1.

According to some embodiments, the granule may be prepared by mixing the polyhalite and SOP in a drum and/or any other suitable machine capable of having a rotation speed of 20-30 rpm.

Adding water 4-10% preferably 7% as spray. According to some embodiments, the mixing may take place at 40-60 C. preferably at 45 C. degrees for 3-5 minutes preferably 3.5 minutes.

After achieving good mixing the mixture may be transferred to a fluidized bed dryer at 100-140 C,, preferably 120 C. for 30-60 minutes preferably 40 minutes.

The granulation process may include the addition of a binder 1-5% binder.

The binder may include but not limited: for example, organic or inorganic binders, such as, starch, bentonite, sodium silicate, lignosulfonates, molasses, hydrated lime, bitumen, Portland cement, clay, cellulose gum, sucrose, water, water glass, cements, Fly Ash, Potassium and Sodium Silicate, MgO, CaO, Alganite, Geo-polymers, oils and waxesand the like, or a combination thereof.

The dry process may include the following steps:

Mixing Polyhalite with Potassium Sulphate according to the formula.

Adding micronutrients.

Sieving of the granules

After sieving there are three types of yield:
1. Desired sized granules “between 1-6 mm, most preferably between 2-4 mm. Around 70% of the granules were between 2-4 mm.
2. Oversized (OS) granules s—are returned to the grinding stage,
3. Undersized (US) granules—are recycled to the mixture for granulation.

According to some embodiments, samples may be taken for analysis.

### EXAMPLE 1

3 Kg of mixture containing 55% polyhalite, potassium sulphate 45% ground to less than 2 mm.

60 gr of activated starch was mixed.

Water—210 cc

Steam was added to the mixture up to 55 C. degree.

The drum operated for 3.5 minutes at 26 rpm.

From the drum the mixture was transferred to a fluidize bed for 45 minutes at 120° C.

Yield was 60%

Strength of resulting granule was 2.6 Kg/granule

### EXAMPLE 2

3 Kg of mixture containing 55% polyhalite, potassium sulphate 45% ground to less than 2 mm with:

60 gr meta kaolin

Yield 60%

Strength of granule 1.4 Kg/granule

### EXAMPLE 3

3 Kg of mixture containing 55% polyhalite, potassium sulphate 45% ground to less than 2 mm with:

60 gr potassium silicate

Yield 60% Strength of granule 0.6 Kg/granule.

### EXAMPLE 4

3 Kg of mixture containing 55% polyhalite, potassium sulphate 45% ground to less than 2 mm with

60 gr sodium silicate

Yield 60%

Strength of granule 0.5 Kg/granule

### EXAMPLE 5

3 Kg of mixture containing 55% polyhalite, potassium sulphate 45% ground to less than 2 mm with:

30 gr activated starch and 30 gr potassium silicate.

Yield 60%

Strength of granule 2.0 Kg/granule

### EXAMPLE 6

3 Kg of mixture containing 70% polyhalite, potassium sulphate 30% ground to less than 2 mm with:

60 gr of activated starch was mixed.

Water—210 cc

Yield 60%

Strength of granule 3.1 Kg/granule.

### EXAMPLE 7

3 Kg of mixture containing 30% polyhalite, potassium sulphate 70% ground to less than 2 mm with:

60 gr of activated starch was mixed.

Water—210 cc

Yield 60%

Strength of granule 2.4 Kg/granule.

Table 1 is a summarizing table of the results of the examples above:

TABLE 1

| | | | | | | | | | | Single | Single | | |
|---|---|---|---|---|---|---|---|---|---|---|---|---|---|
| | | | | Binders | | | | | | strength | strength | | |
| | | | | Meta- | | | | | Single | round 2 | round 3 | | |
| | RAW MATIRIAL | | | Caolin | Ksi | NaSi | STARCH | % | strength | (RECY - | (RECY- | Yield | |
| Sample | SOP | POLY | Grinding | (%) | (%) | (%) | G-242 (%) | H₂O | round 1 | CLED 2/3) | CLED 2/3) | (%) | Dry |
| 1 | 45% | 55% | <2 MM | — | — | — | 2 | 7 | 2.6 | 2.8 | | 60 | 120° fluid bed 45 |
| | | | | | | | | | | | | | min. same result at |
| | | | | | | | | | | | | | 100° for 45 min. |
| 2 | 45% | 55% | <2 MM | 2 | — | — | — | 7 | 1.4 | 1.2 | 1.6 | 60 | 120° fluid bed 45 |
| | | | | | | | | | | | | | min. same result at |
| | | | | | | | | | | | | | 100° for 45 min. |
| 3 | 45% | 55% | <2 MM | — | 2 | — | — | 7 | 0.6 | | | 60 | 120° fluid bed 45 |
| | | | | | | | | | | | | | min. same result at |
| | | | | | | | | | | | | | 100° for 45 min. |
| 4 | 45% | 55% | <2 MM | — | — | 2 | — | 7 | 0.5 | | | 60 | 120° fluid bed 45 |
| | | | | | | | | | | | | | min. same result at |
| | | | | | | | | | | | | | 100° for 45 min. |
| 5 | 45% | 55% | <2 MM | — | 1 | — | 1 | 7 | 2.0 | | | 60 | 120° fluid bed 45 |
| | | | | | | | | | | | | | min. same result at |
| | | | | | | | | | | | | | 100° for 45 min. |
| 6 | 30% | 70% | <2 MM | — | — | — | 2 | 7 | 3.1 | 3.3 | | 60 | 120° fluid bed 45 |
| | | | | | | | | | | | | | min. same result at |
| | | | | | | | | | | | | | 100° for 45 min. |
| 7 | 70% | 30% | <2 MM | — | — | — | 2 | 7 | 2.4 | 2.5 | | 60 | 120° fluid bed 45 |
| | | | | | | | | | | | | | min. same result at |
| | | | | | | | | | | | | | 100° for 45 min. |

While this invention has been described in terms of some specific examples, many modifications and variations are possible. It is therefore understood that within the scope of the appended claims, the invention may be realized otherwise than as specifically described.

1. A fertilizer granule comprising Polyhalite and Sulphate of Potash (SOP), wherein said granule comprises a granule strength of at least 0.5 Kg/granule.

2. The granule of claim 1, wherein said granule further comprises a binder, selected from the group including activated starch, activated starch with potassium silicate; meta kaolin; potassium silicate; sodium silicate or a combination thereof.

3. The granule of claim 2, wherein said binder is activated starch.

4. The granule of claim 3, wherein said activated starch is present in a concentration of 2% w/w.

5. The granule of claim 1, comprising a ratio of polyhalite to SOP of between 1:4 to 4:1.

6. The granule of claim 5, comprising a ratio of polyhalite to SOP of 11:9.

7. A process for the granulation of Polyhalite with SOP comprising:
mixing a feed of polyhalite with a feed of Potassium Sulphate salt and binder in a mixer to yield a mixture;
granulating said mixture in a granulator to yield masses;
crushing said masses in a crusher to yield particles; and
screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

8. The process of claim 7, wherein said particles comprise: N, K₂O, SO₄, MgO and CaO.
